(19) United States
(12) Patent Application Publication
(10) Pub. No.: US 2026/0227624 A1
(43) Pub. Date: Aug. 6, 2026

(54) ACTUATOR AND HIGH-SPEED DRIVE OPTICAL DEVICE

(71) Applicant: TDK CORPORATION, Tokyo (JP)

(72) Inventors: Ryogen FUJIWARA, Tokyo (JP); Nobuyuki SHIMBO, Tokyo (JP)

(73) Assignee: TDK CORPORATION, Tokyo (JP)

(21) Appl. No.: 19/150,783

(22) PCT Filed: Dec. 18, 2023
(86) PCT No.: PCT/JP2023/045349

§ 371 Date: Oct. 29, 2025

(30) Foreign Application Priority Data
Jan. 24, 2023 (JP) 2023-008548

(51) Int. Cl. G02B 26/08; G02B 26/10; H02K 41/03

(52) U.S. Cl. CPC G02B 26/085; G02B 26/101; H02K 41/031; H02K 2201/18

(57) ABSTRACT

This actuator has a fixing member and a member to be driven which is relatively movable with respect to the fixing member. On a pair of opposing surfaces where the member to be driven and the fixing member oppose each other, opposing magnetic members that repulse each other due to respective magnetic forces and form a predetermined space along the Z-axis are disposed. The fixing member is provided with a first magnetic field generation unit that causes magnetic force to act on the magnetic member provided in the member to be driven.

### TECHNICAL FIELD

The present invention relates to an actuator suitable for driving, for example, a MEMS device, and a high-speed driven optical apparatus including that actuator.

### BACKGROUND

Known as an actuator for driving a MEMS device is, for example, an actuator of Patent Document 1 below. In conventional actuators including the actuator of Patent Document 1, a current flows to a coil via a hinge supporting a driven member having a mirror or the like attached. The hinge is turned to drive the driven member, moving the mirror at a high speed.

However, in these conventional actuators including the actuator of Patent Document 1, because the driving coil is disposed on the driven member, it is required to connect the driven member and a fixed member using the hinge or the like and to provide the hinge or the like with wiring. In order to, for example, increase durability of the hinge, it is required for the hinge to have rigidity. However, as the rigidity of the hinge supporting the driven member is increased, the hinge is less readily twisted. This may make it difficult for the driven member to be driven at a high speed.

### PRIOR ARTS

### Patent Document

Patent Document 1: WO2019/065746

### SUMMARY OF INVENTION

### Problem to be solved by Invention

The present invention has been achieved in view of such circumstances. It is an object of the invention to provide a highly durable actuator including a driven member drivable at a high speed and a high-speed driven optical apparatus including the actuator.

### Means for solving the Problem

To achieve the above object, an actuator according to one aspect of the present invention is an actuator including a fixed member and a driven member relatively movable with respect to the fixed member,
wherein
opposing magnetic members in pairs repelling each other using magnetic force to provide a predetermined space therebetween along a first axis are disposed on opposing surfaces in pairs of the driven member and the fixed member respectively; and the fixed member is provided with a first magnetic field generating portion configured
to exert magnetic force on at least one of the opposing magnetic members provided for the driven member to change a length of the predetermined space between the opposing magnetic members.

In the actuator according to the one aspect of the present invention, the opposing magnetic members in pairs repelling each other using the magnetic force to provide the predetermined space therebetween along the first axis (e.g., Z-axis) are disposed on the opposing surfaces in pairs of the driven member and the fixed member respectively. To the at least one of the opposing magnetic members provided for the driven member, supply of a current is unnecessary; and a need for connecting the fixed member and the driven member using a highly rigid hinge or the like is eliminated. Thus, the driven member can magnetically levitate with respect to the fixed member without being connected to the fixed member. Alternatively, the driven member may, while being magnetically levitated with respect to the fixed member, be coupled to the fixed member using an elastic member.

In any case, because the driven member is magnetically levitated with respect to the fixed member, magnetic resonance between the at least one of the opposing magnetic members provided for the driven member and the first magnetic field generating portion can be generated using a magnetic field from the first magnetic field generating portion, making it easy for the driven member to be driven at a high speed with respect to the fixed member. Also, in a situation where the driven member is magnetically levitated with respect to the fixed member without being connected to the fixed member, durability of the actuator improves, without durability or the like of a hinge being brought into question.

Note that, compared to a structure in which the weight of the driven member is supported by only the elastic member, in a structure in which the driven member is coupled to the fixed member using the elastic member while being magnetically levitated with respect to the fixed member, stress exertable on the elastic member is reduced to, in consequence, improve durability of the actuator. Mechanical resonance of the elastic member may be used as well for the driven member to be driven at a high speed.

Preferably, the driven member includes a first surface and a second surface opposite each other. The at least one of the opposing magnetic members provided for the driven member may include a first movable magnetic member on the first surface and a second movable magnetic member on the second surface. At least another one of the opposing magnetic members provided for the fixed member may include a first fixed magnetic member opposing the first movable magnetic member and a second fixed magnetic member opposing the second movable magnetic member. The first magnetic field generating portion may be fixed, at a location where the magnetic force is appropriately exertable on at least either the first movable magnetic member or the second movable magnetic member, to the fixed member.

Such a structure makes it easy to magnetically levitate the driven member with respect to the fixed member and makes it easy to generate magnetic resonance between the at least one of the opposing magnetic members provided for the driven member and the first magnetic field generating portion.

Preferably, the first movable magnetic member includes at least one pair of first end-side magnetic members near opposite ends of the driven member along a second axis (e.g., X-axis) perpendicular to the first axis; and the second movable magnetic member includes a pair of second end-side magnetic members located opposite the at least one pair of first end-side magnetic members across the driven member along the first axis.

Such a structure makes it easy to magnetically levitate the driven member with respect to the fixed member and makes it easy to change the sloping angle of the first surface and the second surface of the driven member at a high speed, with a center of the driven member as a pivot. Consequently, the actuator can be suitably included in optical apparatuses, such as a high-speed driven mirror apparatus.

The fixed member may be provided with a first axis location sensor configured to detect a relative location of the driven member along the first axis with respect to the fixed member; and the actuator may further include a first axis controlling portion configured to control, based on a detection signal from the first axis location sensor, the magnetic force exertable by the first magnetic field generating portion. Such a structure makes it easy to magnetically levitate the driven member with respect to the fixed member and makes it easy to generate magnetic resonance between the at least one of the opposing magnetic members provided for the driven member and the first magnetic field generating portion.

Preferably, a second axis movable magnetic member configured to control a movement of the driven member along the second axis is attached between the at least one pair of first end-side magnetic members located on the first surface of the driven member; and a second magnetic field generating portion is disposed on the fixed member opposing the second axis movable magnetic member with a predetermined space therebetween so that magnetic force is exertable by the second magnetic field generating portion on the second axis movable magnetic member.

Such a structure enables the second magnetic field generating portion to exert force on the second axis movable magnetic member so as to correct misalignment of the driven member in a situation where, for example, gravity or the like may cause misalignment of the driven member along the second axis with respect to the fixed member.

Preferably, the fixed member is provided with a second axis location sensor configured to detect a relative location of the driven member along the second axis with respect to the fixed member; and the actuator further includes a second axis controlling portion configured to control, based on a detection signal from the second axis location sensor, the magnetic force exertable by the second magnetic field generating portion.

Such a structure enables the second axis location sensor to detect misalignment of the driven member and the second axis controlling portion to control the second magnetic field generating portion so as to correct misalignment of the driven member in a situation where, for example, gravity or the like may cause misalignment of the driven member along the second axis with respect to the fixed member.

The second surface of the driven member may have a mirror configured to reflect a light between the pair of second end-side magnetic members. Such a structure enables the actuator according to the one aspect of the present invention to be suitably included in the high-speed driven mirror apparatus or the like.

The first movable magnetic member may include at least one pair of third end-side magnetic members near opposite ends of the driven member along a third axis (e.g., Y-axis) perpendicular to the first axis and the second axis. The second movable magnetic member may include a pair of fourth end-side magnetic members located opposite the at least one pair of third end-side magnetic members across the driven member along the first axis.

Such a structure enables the driven member to be turnably driven around a central imaginary line of the driven member parallel to the third axis and to be turnably driven around a central imaginary line of the driven member parallel to the second axis. Consequently, the first surface and the second surface of the driven member can slope, with a center of the surfaces as a pivot, in any direction nearly along the second axis or the third axis.

The fixed member may be provided with a first axis location sensor configured to detect a relative location of the at least one pair of third end-side magnetic members along the first axis with respect to the fixed member; and the actuator may further include a first axis controlling portion configured to control, based on a signal from the first axis location sensor, the magnetic force exertable by the first magnetic field generating portion. Such a structure makes it easy to magnetically levitate the driven member with respect to the fixed member and makes it easy to generate magnetic resonance between the at least one of the opposing magnetic members provided for the driven member and the first magnetic field generating portion.

A third axis movable magnetic member configured to control a movement of the driven member along the third axis may be attached between the at least one pair of third end-side magnetic members located on the first surface of the driven member. A third magnetic field generating portion may be disposed on the fixed member opposing the third axis movable magnetic member with a predetermined space therebetween so that magnetic force is exertable by the third magnetic field generating portion on the third axis movable magnetic member.

Such a structure enables the third magnetic field generating portion to exert force on the third axis movable magnetic member so as to correct misalignment of the driven member in a situation where, for example, gravity or the like may cause misalignment of the driven member along the third axis with respect to the fixed member.

The fixed member may be provided with a third axis location sensor configured to detect a relative location of the driven member along the third axis with respect to the fixed member. The actuator may further include a third axis controlling portion configured to control, based on a detection signal from the third axis location sensor, the magnetic force exertable by the third magnetic field generating portion.

Such a structure enables the third axis location sensor to detect misalignment of the driven member and the third axis controlling portion to control the third magnetic field generating portion so as to correct misalignment of the driven member in a situation where, for example, gravity or the like may cause misalignment of the driven member along the third axis with respect to the fixed member.

The third axis controlling portion and the second axis controlling portion may be different controllers; however, the third axis controlling portion is preferably a controller collaborating with the second axis controlling portion, or the third axis controlling portion and the second axis controlling portion may constitute the same controller. Collaboration between the second axis controlling portion and the third axis controlling portion (or the controlling portions doubling as each other) enables the controlling portions to provide control for reducing misalignment in the second axis direction or the third axis direction and to provide control for reducing a rotational movement of the driven member around the first axis.

For similar reasons, the second axis location sensor and the third axis location sensor may be different sensors or may constitute the same sensor. Also, the second axis controlling portion and/or the third axis controlling portion preferably collaborates with the first axis controlling portion or may, as a single controller, double as the first axis controlling portion.

Preferably, the at least one of the opposing magnetic members provided for the driven member includes a magnet film that is integrally provided on a surface of the driven member and has a thickness of 300 μm or less. Such a structure enables reduction in weight of the driven member.

Preferably, the magnet film includes a multilayer film including a SmCo₅ film and a Sm₂Co₁₇ film. The magnet film with such a structure has excellent magnetic properties and can be easily manufactured using, for example, a molten salt immersion method.

Preferably, the magnet film has a multilayer structure including a Co layer, the Sm₂Co₁₇ film, and the SmCo₅ film in sequence.

Preferably, no interlayer is present between the Co layer and the Sm₂Co₁₇ film or between the Sm₂Co₁₇ film and the SmCo₅ film of the multilayer structure.

Preferably, an axis of easy magnetization of the SmCo₅ film is oriented in a direction vertical to a surface of the Co layer, and the degree of orientation of the axis of easy magnetization in that direction is 90% or more. The magnet film with such a structure has excellent magnetic properties and can be easily manufactured using, for example, the molten salt immersion method.

While the driven member is magnetically levitated with respect to the fixed member preferably without any contact with the fixed member, the driven member may be coupled to the fixed member using an elastic member with which a movement of the driven member along the second axis is controllable.

A high-speed driven optical apparatus according to one aspect of the present invention includes any actuator described above.

### BRIEF DESCRIPTION OF THE DRAWINGS

FIG. 1A is a schematic sectional view of a high-speed driven mirror apparatus including an actuator according to one embodiment of the present invention.

FIG. 1B is a schematic sectional view of a high-speed driven optical apparatus including an actuator according to another embodiment of the present invention.

FIG. 2A1 is a plan view of the disposition of magnetic members or the like attached to a first fixed member along a line IIAI-IIAI shown in FIG. 1A.

FIG. 2A2 is a plan view of the disposition of magnetic members attached to a driven member along a line IIAII-IIAII shown in FIG. 1A.

FIG. 2A3 is a plan view of the disposition of magnetic members or the like attached to a second fixed member along a line IIAIII-IIAIII shown in FIG. 1A.

FIG. 2B1 is a plan view of the high-speed driven mirror apparatus shown in FIG. 1B, corresponding to FIG. 2A1.

FIG. 2B2 is a plan view of the high-speed driven mirror apparatus shown in FIG. 1B, corresponding to FIG. 2A2.

FIG. 2B3 is a plan view of the high-speed driven mirror apparatus shown in FIG. 1B, corresponding to FIG. 2A3.

FIG. 3 is an exploded perspective view of the high-speed driven mirror apparatus shown in FIG. 1A.

FIG. 4A is a main sectional view of one of the magnetic members provided for the driven member shown in FIG. 1A.

FIG. 4B1 is a main sectional view of a process of manufacturing the magnetic member shown in FIG. 4A.

FIG. 4B2 is a main sectional view of the process of manufacture subsequent to FIG. 4B1.

FIG. 4B3 is a main sectional view of the process of manufacture subsequent to FIG. 4B2.

FIG. 5 is a graph showing simulation results of levitation performance of the high-speed driven mirror apparatus shown in FIG. 3.

### DETAILED DESCRIPTION OF INVENTION

The present invention is described below with reference to embodiments illustrated in the drawings.

Hereinafter, the embodiments illustrated in the drawings are described.

### First Embodiment

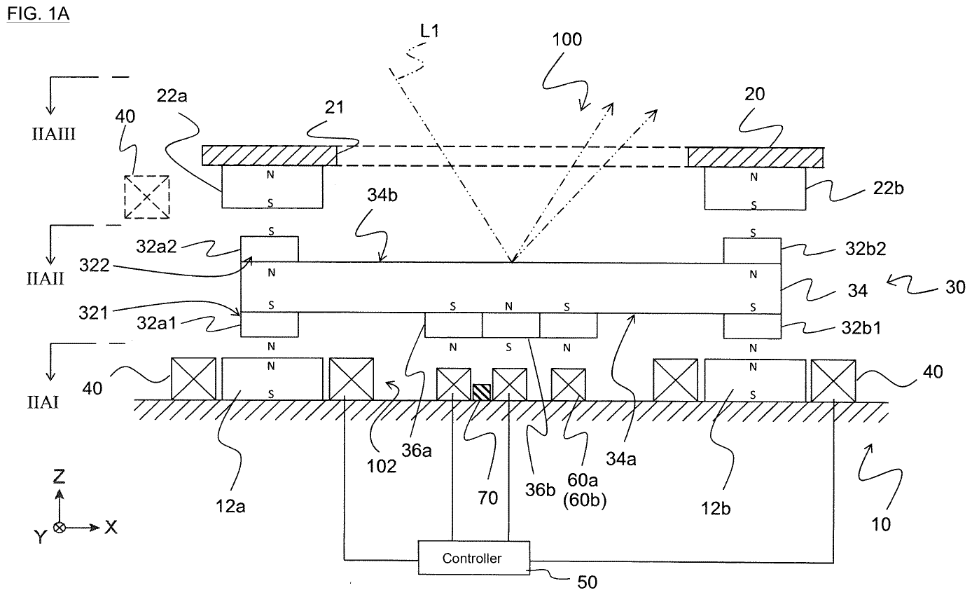

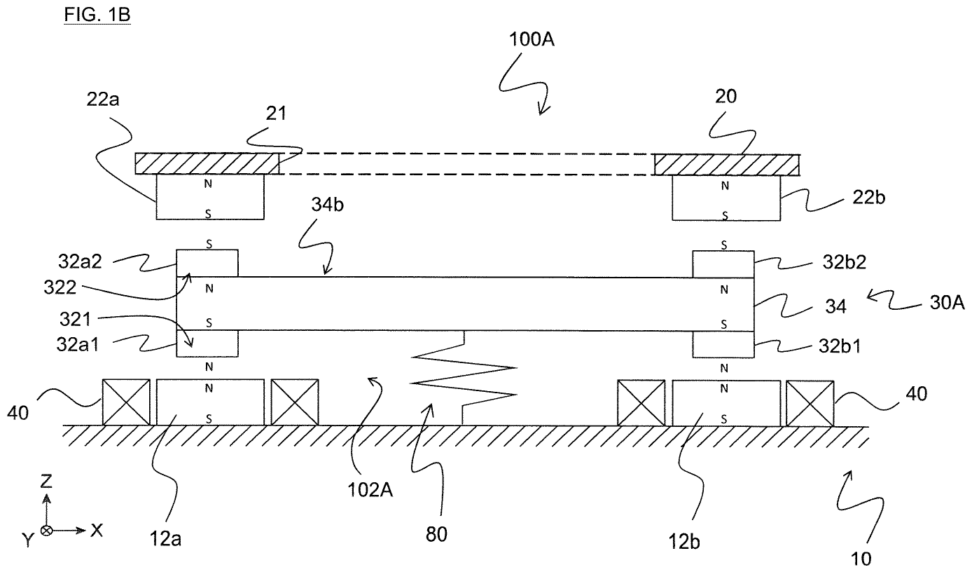

As shown in FIG. 1A, a high-speed driven mirror apparatus 100 as an example high-speed driven optical apparatus according to one embodiment of the present invention includes an actuator 102. The actuator 102 includes a first fixed member 10, a second fixed member 20, and a driven member 30. In the present embodiment, the driven member 30 is located between the first fixed member 10 and the second fixed member 20 along the Z-axis (first axis) and is magnetically levitated by a means described later so as not to be in contact with the first fixed member 10, the second fixed member 20, or other members.

The driven member 30 is relatively movable along the Z-axis, the X-axis (second axis), and the Y-axis (third axis) with respect to the first fixed member 10 and the second fixed member 20. Note that the point is that the first fixed member 10 and the second fixed member 20 are members that do not move relatively with respect to the driven member 30. These fixed members 10 and 20 may move, together with the driven member 30. In a situation where, for example, the fixed members 10 and 20 are attached to a vehicle (e.g., a car), the fixed members 10 and 20 are to move, together with the driven member 30, according to a movement of the vehicle.

In the present embodiment, the X-axis, the Y-axis, and the Z-axis are mutually perpendicular. While the Z-axis corresponds to a vertical direction in the drawings, the Z-axis of the actual apparatus 100 does not necessarily have to be parallel to the vertical direction.

The driven member 30 includes a first surface 34a and a second surface 34b opposite each other along the Z-axis. In FIG. 1A, the driven member 30 includes a substrate 34. A lower surface of the substrate 34 along the Z-axis is defined as the first surface 34a whereas an upper surface of the substrate 34 along the Z-axis is defined as the second surface. The second surface 34b is provided with a mirror, which can reflect, at a predetermined angle, a laser beam L1 entering the mirror at a predetermined angle. The laser beam L1 enters the second surface 34b of the substrate 34 through an opening 21 provided at a central portion of the second fixed member 20 having a plate shape, is reflected by the mirror provided on the second surface 34b, and exits through the opening 21 of the second fixed member 20.

The first surface 34a of the substrate 34 as the driven member 30 is provided with a first movable magnetic member 321. The second surface 34b thereof is provided with a second movable magnetic member 322. The first movable magnetic member 321 includes at least one pair of first end-side magnetic members 32al and 32b1, which are provided near opposite ends, along the X-axis, of the substrate 34 having a rectangular shape. The second movable magnetic member 322 includes a pair of second end-side magnetic members 32a2 and 32b2, which are located opposite the first end-side magnetic members 32a1 and 32b1 respectively across the substrate 34 along the Z-axis.

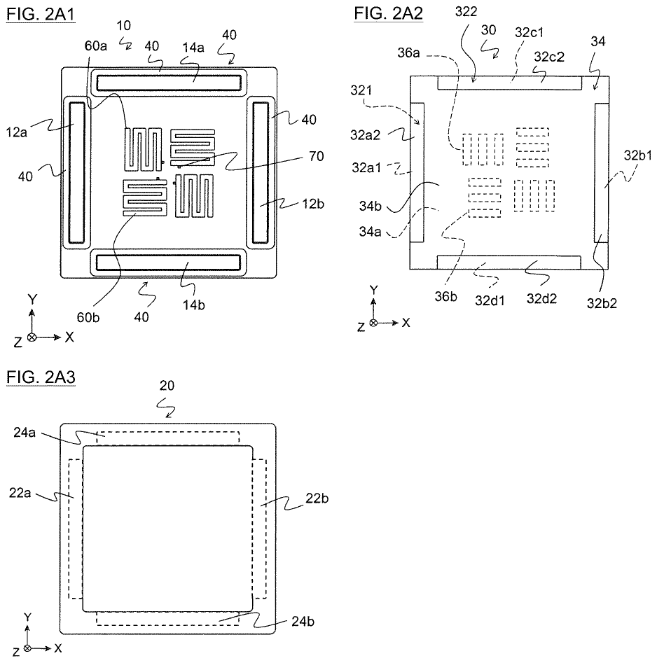

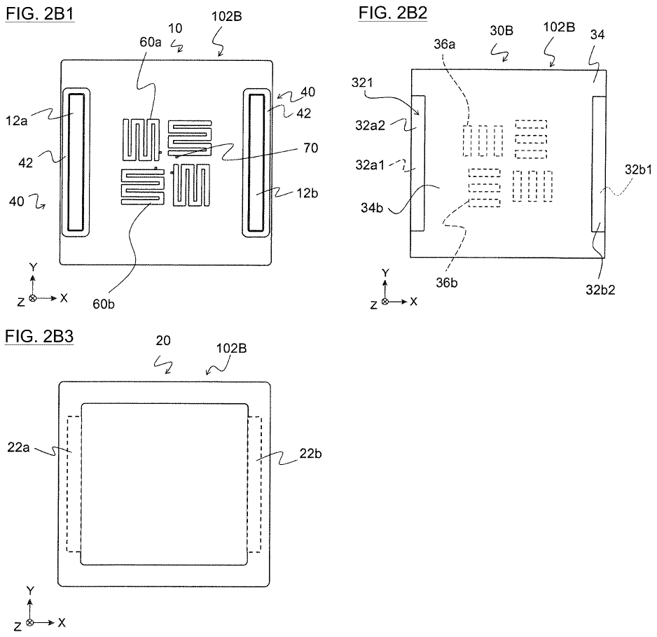

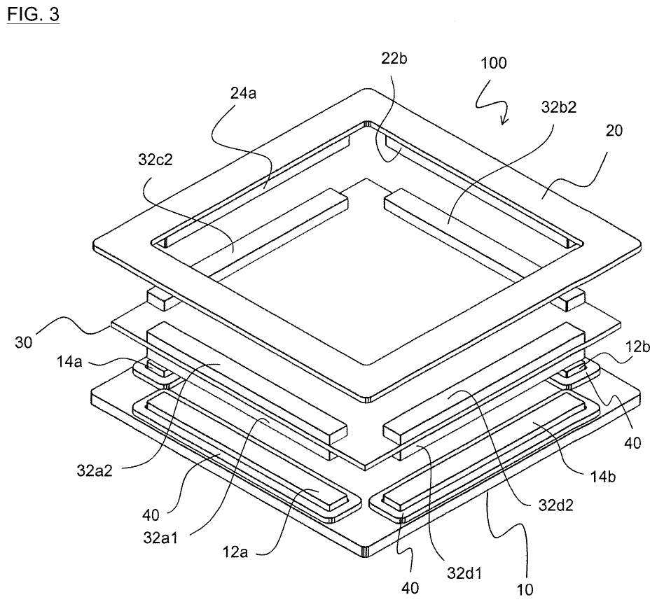

As shown in FIG. 2A2, viewed from the Z-axis direction, the pair of first end-side magnetic members 32a1 and 32b1 and the pair of second end-side magnetic members 32a2 and 32b2 are elongated along sides, parallel to the Y-axis, of the ends, along the X-axis, of the substrate 34 having the rectangular shape.

In the present embodiment, as shown in FIG. 2A2, the first movable magnetic member 321 includes at least one pair of third end-side magnetic members 32c1 and 32d1, which are provided near opposite ends, along the Y-axis, of the substrate 34 having the rectangular shape. The second movable magnetic member 322 includes a pair of fourth end-side magnetic members 32c2 and 32d2, which are located opposite the third end-side magnetic members 32c1 and 32d1 respectively across the substrate 34 along the Z-axis.

Viewed from the Z-axis direction, the pair of third end-side magnetic members 32cl and 32d1 and the pair of fourth end-side magnetic members 32c2 and 32d2 are elongated along sides, parallel to the X-axis, of the ends, along the Y-axis, of the substrate 34 having the rectangular shape. On the first surface 34a of the substrate 34, the respective end-side magnetic members 32a1, 32b1, 32c1, and 32d1 are provided along the four sides of the substrate 34 having the rectangular shape. These four end-side magnetic members 32a1, 32b1, 32c1, and 32d1 are provided on the first surface 34a so as to be independent of one another and not to be in contact with one another.

On the second surface 34b of the substrate 34, the respective end-side magnetic members 32a2, 32b2, 32c2, and 32d2 are provided along the four sides of the substrate 34 having the rectangular shape. These four end-side magnetic members 32a2, 32b2, 32c2, and 32d2 are provided on the second surface 34b so as to be independent of one another and not to be in contact with one another.

While the end-side magnetic members 32a2, 32b2, 32c2, and 32d2 are separately disposed on the second surface 34b of the substrate 34 along the four sides of the substrate 34 having the rectangular shape, a central portion of the second surface of the substrate 34 is provided with the mirror (omitted in the drawings) having, for example, a rectangular shape or another shape. While the end-side magnetic members 32a1, 32b1, 32c1, and 32d1 are separately disposed on the first surface 34a of the substrate 34 along the four sides of the substrate 34 having the rectangular shape, a central portion of the first surface of the substrate 34 is provided with an X-axis movable magnetic member 36a and a Y-axis movable magnetic member 36b in a predetermined pattern.

The X-axis movable magnetic member 36a and the Y-axis movable magnetic member 36b can be provided in the predetermined pattern on the first surface 34a of the substrate 34 so as to be surrounded by the four end-side magnetic members 32a1, 32b1, 32c1, and 32d1, using a method similar to a method (described later) of providing them.

As shown in FIGS. 1A and 2A1, on a surface of the first fixed member 10, first fixed magnetic members 12a and 12b are provided at locations opposing the first surface 34a of the substrate 34 so as to oppose the first end-side magnetic members 32al and 32b1, respectively. The first fixed magnetic members 12a and 12b, which oppose the first end-side magnetic members 32a1 and 32b1 respectively, are magnetized so that mutual magnetic repulsion occurs.

As shown in FIG. 2A1 and 2A2, on the surface of the first fixed member 10, first fixed magnetic members 14a and 14b are provided at locations opposing the first surface 34a of the substrate 34 so as to oppose the third end-side magnetic members 32c1 and 32d1, respectively. The first fixed magnetic members 14a and 14b, which oppose the third end-side magnetic members 32cl and 32d1 respectively, are magnetized so that mutual magnetic repulsion occurs.

As shown in FIGS. 1A and 2A3, on a surface (lower surface along the Z-axis) of the second fixed member 20, second fixed magnetic members 22a and 22b are provided at locations opposing the second surface 34b of the substrate 34 so as to oppose the second end-side magnetic members 32a2 and 32b2, respectively. The second fixed magnetic members 22a and 22b, which oppose the second end-side magnetic members 32a2 and 32b2 respectively, are magnetized so that mutual magnetic repulsion occurs.

As shown in FIG. 2A2 and 2A3, on the surface of the second fixed member 20, second fixed magnetic members 24a and 24b are provided at locations opposing the second surface 34b of the substrate 34 so as to oppose the fourth end-side magnetic members 32c2 and 32d2, respectively. The second fixed magnetic members 24a and 24b, which oppose the fourth end-side magnetic members 32c2 and 32d2 respectively, are magnetized so that mutual magnetic repulsion occurs.

That is, the four end-side magnetic members 32a1, 32b1, 32c1, and 32d1 provided on the first surface 34a of the substrate 34 oppose the four first fixed magnetic members 12a, 12b, 14a, and 14b provided on the first fixed member 10, respectively. Each pair constitutes opposing magnetic members that repel each other with a predetermined space therebetween. Likewise, the four end-side magnetic members 32a2, 32b2, 32c2, and 32d2 provided on the second surface 34b of the substrate 34 oppose the four second fixed magnetic members 22a, 22b, 24a, and 24b provided on the second fixed member 20, respectively. Each pair constitutes opposing magnetic members that repel each other with a predetermined space therebetween.

In the present embodiment, on the surface of the first fixed member 10, respective first magnetic field generating portions 40 are provided around or near the first fixed magnetic members 12a, 12b, 14a, and 14b. Each first magnetic field generating portion 40 constitutes an energizable coil device and is controlled by an X-axis controlling portion (second axis controlling portion) of a controller 50. The respective first magnetic field generating portions 40 can apply a magnetic field to the nearest end-side magnetic members 32a1 to 32d1 of the first movable magnetic member 321 to minutely move the ends of the substrate 34 along the Z-axis.

As shown in FIG. 2A2, provided between the pair of first end-side magnetic members 32a1 and 32b1 and between the pair of third end-side magnetic members 32c1 and 32d1 on the first surface 34a of the substrate 34 are the X-axis movable magnetic member 36a, which controls a movement of the substrate 34 along the X-axis, and the Y-axis movable magnetic member 36b, which controls a movement of the substrate 34 along the Y-axis.

These movable magnetic members 36a and 36b are composed of, for example, permanent magnet films described later and are integrally provided on the surface of the substrate similarly to the magnetic members 32a1 to 32d1 and 32a2 to 32d2 described earlier.

On the first fixed member 10, which, with a predetermined space in between, opposes the X-axis movable magnetic member 36a and the Y-axis movable magnetic member 36b, a second magnetic field generating portion 60a and a third magnetic field generating portion 60b are disposed so that magnetic force can be applied to the X-axis movable magnetic member 36a and the Y-axis movable magnetic member 36b, respectively. The second magnetic field generating portion 60a and the third magnetic field generating portion 60b each constitute a coil device capable of generating a magnetic field and are controlled by the X-axis controlling portion (second axis controlling portion) or a Y-axis controlling portion (third axis controlling portion) of the controller 50.

A magnetic field generated at the second magnetic field generating portion 60a is exertable on the X-axis movable magnetic member 36a shown in FIG. 2A2. This magnetic field controls a movement of the substrate 34, to which the X-axis movable magnetic member 36a is attached, along the X-axis to control the relative location of the driven member 30 in the X-axis direction with respect to the fixed members 10 and 20 so that the relative location is kept stable. Likewise, a magnetic field generated at the third magnetic field generating portion 60b is exertable on the Y-axis movable magnetic member 36b shown in FIG. 2A2. This magnetic field controls a movement of the substrate 34, to which the Y-axis movable magnetic member 36b is attached, along the Y-axis to control the relative location of the driven member 30 in the Y-axis direction with respect to the fixed members 10 and 20 so that the relative location is kept stable.

The first fixed member 10, the second fixed member 20, or other fixed members are preferably provided with a location sensor 70, which detects the relative locations of the driven member 30 at least in the X-axis direction and the Z-axis direction with respect to these fixed members. In the present embodiment, as the location sensor 70, a magnetic sensor (e.g., a Hall sensor) is used; however, the location sensor 70 is not limited to the magnetic sensor and may be an optical sensor or the like.

In the present embodiment, the location sensor 70 detects the relative location of the driven member 30 at least in the X-axis direction and the Z-axis direction; however, the sensor 70 may detect the relative location of the driven member 30 or the substrate 34 along the Z-axis. Alternatively, sensors that detect the relative locations of the driven member 30 in the X-axis direction, the Y-axis direction, and the Z-axis direction may be different sensors. Similarly, while the controller 50 includes the X-axis controlling portion, the Y-axis controlling portion, and the Z-axis controlling portion in the present embodiment, these controlling portions may constitute different controllers. However, the X-axis controlling portion, the Y-axis controlling portion, and the Z-axis controlling portion preferably collaborate.

A coil pattern of the magnetic field generating portion 60a shown in FIG. 2A1 and a disposition pattern of the movable magnetic member 36a shown in FIG. 2A2 are not limited provided that a magnetic field generated at the magnetic field generating portion 60a is applicable to the movable magnetic member 36a to exert electromagnetic force on the movable magnetic member 36a along the X-axis. Similarly, a coil pattern of the magnetic field generating portion 60b shown in FIG. 2A1 and a disposition pattern of the movable magnetic member 36b shown in FIG. 2A2 are not limited provided that a magnetic field generated at the magnetic field generating portion 60b is applicable to the movable magnetic member 36b to exert electromagnetic force on the movable magnetic member 36b along the Y-axis.

The sensor 70 detects, for example, the relative location of the substrate 34 in the X-axis direction and the relative location of the substrate 34 in the Y-axis direction with respect to the fixed members 10 and 20 and transmits a detection signal to the controller 50. Based on the detection signal, the X-axis controlling portion and the Y-axis controlling portion of the controller 50 control magnetic fields generated at the magnetic field generating portions 60a and 60b to change the intensities and the polarities of the magnetic fields applicable to the movable magnetic members 36a and 36b, controlling the relative locations of the substrate 34 along the X-axis and the Y-axis with respect to the fixed members 10 and 20.

Now, structures of the magnetic members 32a1 to 32d1, 32a2 to 32d2, and 36a and 36b provided on the first surface 34a or the second surface 34b of the substrate 34 are described in detail.

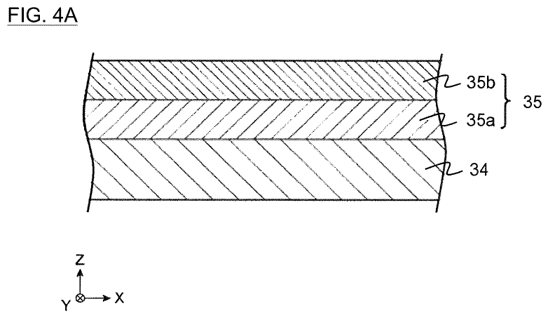

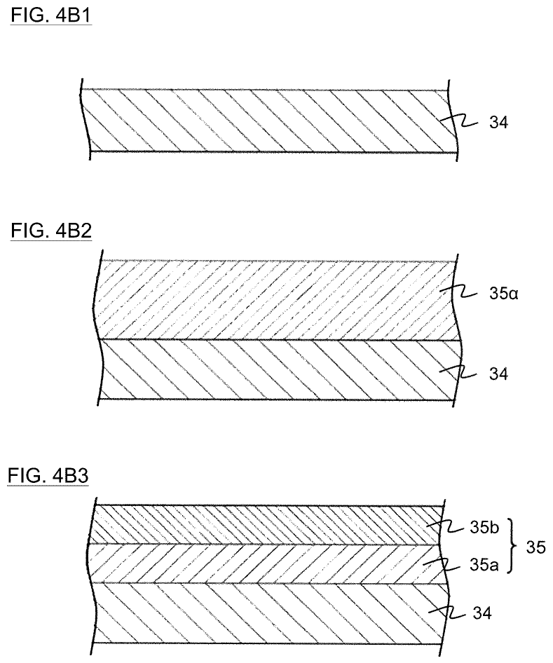

As shown in FIG. 4A, each of the magnetic members 32a1 to 32d1, 32a2 to 32d2, and 36a and 36b is composed of a permanent magnet film 35 integrally provided on the surface of the substrate 34 (the first surface 34a or the second surface 34b in FIG. 1A). The magnet film 35 includes, for example, a first film 35a directly provided on the surface of the substrate 34 and a second film 35b directly provided on the first film 35a. In the present embodiment, the first film 35a is composed of a Sm₂Co₁₇ film whereas the second film 35b is composed of a SmCo₅ film. Between the surface of the substrate 34 and the first film 35a and between the first film 35a and the second film 35b (between layers of the multilayer structure), an interlayer of a non-magnetic material (e.g., an oxide layer, a resin layer, and an adhesive layer) having a thickness larger than 0.5 to 4 nm at a resolution observable with a scanning electron microscope (SEM) is preferably not interposed; however, there may be an interlayer having a thickness smaller than 0.5 to 4 nm at such a resolution.

In the present embodiment, the Sm₂Co₁₇ film constituting the first film 35a contains Sm₂Co₁₇ as a main phase. Sm₂Co₁₇ has a Th₂Zn₁₇ type crystal structure and is an alloy of Sm and Co. The ratio of Sm atoms to Co atoms of Sm₂Co₁₇ may deviate from the stoichiometric ratio. The ratio of Sm atoms to Co atoms of Sm₂Co₁₇ may not necessarily be the stoichiometric ratio if, for example, various elements are added for improvement of magnetic properties or the like. Thus, provided that Sm₂Co₁₇ has the Th₂Zn₁₇ type crystal structure, the ratio of Sm atoms to Co atoms may deviate from the stoichiometric ratio.

In the specification of this application, “as a main phase” indicates the highest mass proportion of the film. The Sm₂Co₁₇ film may include phases different from Sm₂Co₁₇, such as other crystal phases, and grain boundary phases. The proportion of Sm₂Co₁₇ in the Sm₂Co₁₇ film may be, for example, 70 mass % or more, 80 mass % or more, 90 mass % or more, or 95 mass % or more.

The thickness of the first film 35a is not limited and can be appropriately selected according to a use. The thickness can be, for example, 1 to 100 μm. The thickness of the first film 35a can be measured by embedding the magnet film 35 in a resin, polishing the resultant sample to expose a section of the magnet film 35 from the resin, and observing the exposed section of the magnet film 35 with a scanning electron microscope (SEM).

The SmCo₅ film as the second film 35b contains SmCo₅ as a main phase. SmCo₅ has a CaCu₅ type crystal structure and is an alloy of Sm and Co. The ratio of Sm atoms to Co atoms of SmCo₅ may deviate from the stoichiometric ratio. The ratio of Sm atoms to Co atoms of SmCo₅ may not necessarily be the stoichiometric ratio if, for example, various elements are added for improvement of magnetic properties or the like. Thus, provided that SmCo₅ has the CaCu₅ type crystal structure, the ratio of Sm atoms to Co atoms may deviate from the stoichiometric ratio.

The SmCo₅ film may include phases different from SmCo₅, such as other crystal phases, and grain boundary phases. The proportion of SmCo₅ in the SmCo₅ film may be, for example, 70 mass % or more, 80 mass % or more, 90 mass % or more, or 95 mass % or more. Examples of different phases include a Sm-rich phase with a higher proportion of Sm than that of SmCo₅.

The crystal orientation [00L] of the SmCo₅ film is oriented in the thickness direction of the SmCo₅ film, i.e., direction perpendicular to a film surface. L is any natural number. No matter what natural number L is, the direction is the same. L is, for example, 2. That the crystal orientation [00L] of the SmCo₅ film is oriented in the thickness direction of the SmCo₅ film means that the degree of orientation is 50% or more. The degree of orientation is based on the Lotgering method with vector correction. The degree of orientation indicates the ratio of the sum of diffraction peaks corresponding to the crystal orientation [00L] component to the sum of diffraction peaks corresponding to a crystal plane (hkl) of the SmCo₅ film. For further improvement of surface magnetic flux density of the magnet film 35, the degree of orientation is preferably 90% or more or is more preferably 95% or more.

The thickness of the SmCo₅ film is preferably 10 μm or more in terms of further improvement the surface magnetic flux density of the magnet film 35. The upper limit of the thickness of the SmCo₅ film is not limited but may be, for example, 300 μm or less. The thickness of the second film 35b composed of the SmCo₅ film can be measured similarly to the thickness of the first film 35a.

A film surface of the second film 35b opposite its surface in contact with the first film 35a may be partly or entirely covered with other films (e.g., a Sm₂O₃ film) or may not be covered with such films. The total thickness of the magnet film 35 including the first film 35a and the second film 35b is not limited and can be appropriately changed according to a use. The total thickness may be, for example, 0.01 to 2 mm.

The planar shape of the magnet film 35 is not limited. The planar shape is, for example, that of the four end-side magnetic members 32a1, 32b1, 32c1, and 32d1 or the four end-side magnetic members 32a2, 32b2, 32c2, and 32d2 along the four sides of the substrate 34 in the rectangular shape as shown in FIG. 2A2. Alternatively, the planar shape of the magnet film 35 may be in stripes as shown by the X-axis movable magnetic member 36a and the Y-axis movable magnetic member 36b.

In the present embodiment, the substrate 34 in the rectangular shape has a size preferably measuring about 1 to 10 mm lengthwise by 1 to 10 mm widthwise. The planar shape of the magnet film 35 has a size of about 1/10 to about ⅘ of the substrate 34 lengthwise or widthwise.

The surface magnetic flux density of the magnet film 35 is preferably 5 mT or more, more preferably 7 mT or more, or still more preferably 10 mT or more. The surface magnetic flux density of the magnet film 35 can be measured by, for example, bringing a probe of a Hall sensor into contact with the film surface of the SmCo₅ film of the magnet film 35, tracing the surface, and converting an output voltage into magnetic flux density.

It is assumed that, in the present embodiment, the first film 35a functions as a yoke whereas the second film 35b functions as a magnet. That is, the magnet film 35 includes the first film 35a, which is composed of the soft magnetic Sm₂Co₁₇ film having higher saturation magnetization than that of SmCo₅ as the second film 35b. This enables the Sm₂Co₁₇ film to work as a back yoke collecting a magnetic flux. Moreover, the crystal orientation [00L] of the SmCo₅ film is oriented in the thickness direction of the SmCo₅ film. That is, the crystal orientation [00L], which is the axis of easy magnetization of SmCo₅, and the film thickness direction of the SmCo₅ film (direction perpendicular to the film surface (Z-axis direction)) match. This increases the surface magnetic flux density of the magnet film 35. Also, having a high Curie temperature, which is 700° C. or more, SmCo₅ has high thermal stability.

In the present embodiment, preferred as the substrate 34 is a substrate on which the first film 35a is directly provided. The substrate 34 is, for example, preferably a Co substrate. In a situation where the Co substrate is used as the substrate 34, preferred is a metal Co plate. The Co substrate may have a Co purity of 99 mass % or more or a Co purity of 99.998 mass % or more. Under the Co substrate may be another substrate. The thickness of the Co substrate is not limited and can be appropriately selected according to a use. The thickness can be, for example, 0.01 to 2 mm.

Now, a method of manufacturing the SmCo based magnet film 35 is described in detail. As an example, a situation where a Co substrate is used as the substrate 34 is described. First, as shown in FIG. 4B1, the substrate 34 composed of the Co substrate is prepared. Then, as shown in FIG. 4B2, on a surface of the substrate 34, a laminated film including a SmCo₂ film 35a is formed.

Every magnet film 35 having the multilayer structure is manufactured preferably using a molten salt immersion method or a method utilizing the molten salt immersion method. First, the Co substrate and a reaction liquid including a Sm source and a molten salt are prepared. For the manufacture of the magnet film 35, the Co substrate having, for example, a plate shape is prepared.

For preparation of the reaction liquid, first, a predetermined inorganic salt is dried for dehydration. Examples of inorganic salts include KCl (potassium chloride), LiCl (lithium chloride), and NaCl (sodium chloride). One inorganic salt may be used, or at least two inorganic salts may be used in combination. The dehydrated inorganic salt is heated to a predetermined temperature to melt the inorganic salt (molten salt). The temperature at which the inorganic salt is melted is appropriately determined according to the type of the inorganic salt being used. The temperature is, for example, preferably 400° C. or more, more preferably 500° C. or more, or still more preferably 600° C. or more.

To the above molten salt (melted inorganic salt), the Sm source is added to give the reaction liquid. Examples of Sm sources include metal Sm and Sm alloys. One Sm source may be used, or at least two Sm sources may be used. Out of a total of 100 mol % of the number of moles of the Sm source and the number of moles of the inorganic salt in the reaction liquid, the proportion of the Sm source in the reaction liquid is, for example, preferably 0.2 mol % or more and 6 mol % or less. Note that, in a situation where an additional element is added to the Sm₂Co₁₇ layer or/and the SmCo₅ layer, a raw material containing the desired additional element is added to the molten salt, together with the Sm source.

Then, the above reaction liquid is brought into contact with a surface of the Co substrate to cause reaction-diffusion between the surface of the Co substrate and the Sm source in the molten salt. This forms a magnetic film containing Sm on an inner circumferential surface of the Co substrate. This step is referred to as a reaction-diffusion step.

In the reaction-diffusion step during the manufacture of the magnet film 35, the Co substrate having the plate shape is immersed in the reaction liquid at a predetermined temperature for a predetermined amount of time to form the magnetic film containing Sm on both surfaces of the Co substrate. However, immersing the magnet film 35 directly in the reaction liquid forms the magnetic film containing Sm also in a region where no magnetic film is necessary, reducing yield. Thus, an effort is needed for preventing reaction-diffusion in the region where no magnetic film is necessary by covering the region with an inert film.

For example, a mask of a material with a high melting point is preferably formed in the region where no magnetic film is necessary. Examples of materials with a high melting point include W, Ta, Nb, Mo, and an alloy containing at least one of these elements. The mask of the material with a high melting point is formed using, for example, a vapor deposition method. By forming the mask of the material with a high melting point on an outer circumferential surface and end surfaces and then immersing the Co substrate in the reaction liquid, reaction-diffusion of the Sm source occurs only in a region of the Co substrate where the magnetic film is necessary. The magnetic film containing Sm can thus be formed.

In the reaction-diffusion step, the temperature of the reaction liquid is held at a temperature at which the inorganic salt can be in a molten state. In terms of efficient formation of the magnetic film, the temperature of the reaction liquid is preferably 500° C. or more and 900° C. or less or is more preferably 650° C. or more and 800° C. or less. The reaction time is appropriately determined according to the reaction temperature or the proportion of the Sm source in the reaction liquid so that the magnetic film can have a desired thickness. The reaction time may be, for example, 1 hour or more and 48 hours or less.

The magnetic film formed on the surface of the Co substrate in the reaction-diffusion step is a precursor of the Sm₂Co₁₇ layer and the SmCo₅ layer. Specifically, the magnetic film after the reaction-diffusion step preferably contains SmCo₂ as a main phase. SmCo₂ is an alloy of Sm and Co having a MgCu₂ type crystal structure. Provided that SmCo₂ (main phase) has the MgCu₂ type crystal structure, the ratio of Sm atoms to Co atoms of SmCo₂ may slightly deviate from the stoichiometric ratio. In a situation where, for example, an additional element is added for improvement of magnetic properties, the ratio of Sm atoms to Co atoms may slightly deviate from the stoichiometric ratio.

The magnetic film may include, other than the main phase, different phases (e.g., a Sm-rich phase with a higher proportion of Sm than that of SmCo₂) and grain boundary phases. The proportion of SmCo₂ in the magnetic film may be 50 wt % or more, preferably 70 wt % or more, or more preferably 90 wt % or more.

After the reaction-diffusion step, the Co substrate with the magnetic film may be washed with an organic solvent (e.g., ethanol) or purified water.

Then, the Co substrate with the magnetic film containing SmCo₂ is heated at a predetermined temperature for a predetermined amount of time (heating step). In this heating step, reaction between SmCo₂ and Co of the substrate further proceeds to generate the Sm₂Co₁₇ layer and the SmCo₅ layer from the surface of the Co substrate and the magnetic film.

The heating rate in the heating step is not limited. The heating rate is, for example, preferably 1° C./min or more and 20° C./min or less. The holding temperature (reached temperature) is preferably 800° C. or more and 1200° C. or less, more preferably 850° C. or more and 1150° C. or less, or still more preferably 900° C. or more and 1100° C. or less. The holding time at the above holding temperature is, for example, preferably 2 hours or more and 48 hours or less. The cooling rate at the time of cooling after heating is preferably 5° C./min or more, more preferably 10° C./min or more, or still more preferably 20° C./min or more.

The atmosphere of the heating step is not limited. In terms of prevention of oxidation of the SmCo₅ layer, the atmosphere is preferably an inert gas atmosphere. As an inert gas, for example, an Ar gas, a N₂ gas, or the like is used.

The magnet film 35 having the multilayer structure can be manufactured through the above steps (the reaction-diffusion step and the heating step). Of the magnet film 35, the Sm₂Co₁₇ layer and the SmCo₅ layer are formed on the surface of the Co substrate in sequence to give the multilayer structure. In a situation where the mask of the material with a high melting point is formed on the surface of the Co substrate, this mask may be removed after the heating step or may remain there.

In the present embodiment, the magnetic members 12a, 12b, 14a, 14b, 22a, 22b, 24a, and 24b provided for the fixed members 10 and 20 can be composed of magnet films 35 having the same structures as those of the magnetic members provided for the substrate 34 of the driven member 30 described above but may be composed of typical sintered magnets (e.g., rare-earth magnets), bonded magnets, or the like. Unlike the magnetic members 32a1 to 32d1, 32a2 to 32d2, and 36a and 36b provided for the magnetically levitated substrate 34, the magnetic members 12a, 12b, 14a, 14b, 22a, 22b, 24a, and 24b provided for the fixed members 10 and 20 are not that much required to be thinned, reduced in weight, or the like.

According to the actuator 102 including, as the driven member 30, the substrate 34 including the magnetic members 32a1 to 32d1, 32a2 to 32d2, and 36a and 36b composed of the magnet films 35 according to the present embodiment, the following effects can be expected.

For example, the first fixed magnetic members 12a, 12b, 14a, and 14b and the end-side magnetic members 32a1 to 32d1, which oppose those first fixed magnetic members respectively, repel each other with magnetic force; and the second fixed magnetic members 22a, 22b, 24a, and 24b and the end-side magnetic members 32a2 to 32d2, which oppose those second fixed magnetic members respectively, repel each other with magnetic force. Consequently, the substrate 34 as the driven member 30 is magnetically levitatable between the first fixed member 10 and the second fixed member 20.

Under this condition, for example, the first axis controlling portion of the controller 50 transmits a signal to the pair of first magnetic field generating portions 40 located opposite each other along the X-axis to apply magnetic fields to the pair of first end-side magnetic members 32a1 and 32b1, located opposite each other along the X-axis, at predetermined frequencies. The magnetic fields applied to the first end-side magnetic members 32a1 and 32b1 preferably have, for example, opposite phases. For example, while the magnetic field directed in a direction in which the end-side magnetic member 32a1 moves away from the first fixed magnetic member 12a is applied to this end-side magnetic member 32a1, at the same time, the magnetic field directed in a direction in which the other end-side magnetic member 32b1 moves toward the first fixed magnetic member 12b is applied to the end-side magnetic member 32b1.

Such a control enables both ends, along the X-axis, of the magnetically levitated substrate 34 to minutely pivot (turn) on a central axis of the substrate along the Y-axis at a high speed at a predetermined minute angle. It is assumed that appropriately selecting the frequencies of the magnetic fields applied to the first end-side magnetic members 32a1 and 32b1 causes magnetic resonance.

Similarly, for example, the first axis controlling portion of the controller 50 transmits a signal to the other pair of first magnetic field generating portions 40 located opposite each other along the Y-axis to apply magnetic fields to the pair of third end-side magnetic members 32c1 and 32d1, located opposite each other along the Y-axis, at predetermined frequencies. The magnetic fields applied to the third end-side magnetic members 32c1 and 32d1 preferably have, for example, opposite phases. For example, while the magnetic field directed in a direction in which the end-side magnetic member 32c1 moves away from the first fixed magnetic member 14a is applied to this end-side magnetic member 32c1, at the same time, the magnetic field directed in a direction in which the other end-side magnetic member 32d1 moves toward the first fixed magnetic member 14b is applied to the end-side magnetic member 32d1.

Such a control enables both ends, along the Y-axis, of the magnetically levitated substrate 34 to minutely pivot on a central axis of the substrate along the X-axis at a high speed at a predetermined minute angle. It is assumed that appropriately selecting the frequencies of the magnetic fields applied to the third end-side magnetic members 32c1 and 32d1 causes magnetic resonance.

Note that the first fixed member 10, the second fixed member 20, or other fixed members are provided with a Z-axis sensor (omitted in the drawings), which can measure relative locations of the end-side magnetic members 32a1 to 32d1 and/or the end-side magnetic members 32a2 to 32d2 along the Z-axis with respect to the fixed members. A detection signal from the Z-axis sensor is input to the first axis controlling portion of the controller 50. The first axis controlling portion transmits signals to the first magnetic field generating portions 40 and, according to the detection signal from the Z-axis sensor or the like, controls respective magnetic fields output from the first magnetic field generating portions 40. Consequently, minute angles, frequencies, switching of rotational axes, sweep widths, or the like of pivoting of the magnetically levitated substrate 34 can be controlled.

In this manner, in the actuator 102 according to the present embodiment, the opposing magnetic members (e.g., the magnetic members 12a and 32a1 in pairs in FIG. 1A), which repel each other with magnetic force to provide the predetermined space therebetween along the Z-axis, are disposed on the opposing surfaces in pairs of the driven member 30 and the fixed members 10 and 20. To the opposing magnetic members 32a1 to 32d1 and 32a2 to 32d2 provided for the driven member 30, supply of currents is unnecessary; and a need for connecting the fixed member 10 or 20 and the driven member 30 using a highly rigid hinge or the like is eliminated. Thus, the driven member 30 can magnetically levitate with respect to the fixed members 10 and 20 without being connected to the fixed members 10 and 20.

Because the driven member 30 is magnetically levitated with respect to the fixed members 10 and 20, magnetic resonance between the end-side magnetic members 32a1 to 32d1 provided for the driven member 30 and the first magnetic field generating portions 40 can be generated using magnetic fields from the first magnetic field generating portions 40, making it easy for the driven member 30 to be pivotably driven at a high speed with respect to the fixed members 10 and 20. Also, in a situation where the driven member 30 is magnetically levitated with respect to the fixed members 10 and 20 without being connected to the fixed members 10 and 20, durability of the actuator improves, without durability or the like of a hinge being brought into question.

In the present embodiment, the substrate 34 as the driven member 30 is disposed between the fixed members 10 and 20 to be magnetically levitated using magnetically repelling force of the magnetic members disposed between them. This makes it easy for the driven member 30 to magnetically levitate with respect to the fixed members 10 and 20 and makes it easy to generate magnetic resonance between the magnetic members 32al to 32d1 (or 32a2 to 32d2) provided for the driven member 30 and the first magnetic field generating portions 40.

Moreover, in the present embodiment, at least one pair of first end-side magnetic members 32a1 and 32b1, which are provided near the opposite ends of the driven member 30 along the X-axis, and the pair of second end-side magnetic members 32a2 and 32b2, which are located opposite the first end-side magnetic members 32a1 and 32b1 across the substrate 34 along the Z-axis, are included. This structure makes it easy to magnetically levitate the driven member 30 with respect to the fixed members 10 and 20 and makes it easy to change the sloping angle of the first surface 34a and the second surface 34b of the driven member 30 at a high speed, with the central axis of the driven member 30 along the Y-axis as a pivot.

Similarly, at least one pair of third end-side magnetic members 32c1 and 32d1, which are provided near the opposite ends of the driven member 30 along the Y-axis, and the pair of fourth end-side magnetic members 32c2 and 32d2, which are located opposite the third end-side magnetic members 32c1 and 32d1 across the substrate 34 along the Z-axis, are included. This structure makes it easy to magnetically levitate the driven member 30 with respect to the fixed members 10 and 20 and makes it easy to change the sloping angle of the first surface 34a and the second surface 34b of the driven member 30 at a high speed, with the central axis of the driven member 30 along the X-axis as a pivot.

Consequently, the substrate 34 can be pivoted on the central axes along both the X-axis and the Y-axis. The second surface 34b of the driven member 30 can thus slope, with a center of the surface as a pivot, in any direction nearly along the X-axis or the Y-axis at a high speed. Thus, reflection of a light that enters the mirror attached to the second surface 34b can have orientation of the light changed at a high speed. This enables a two-dimensional scanning movement of a light, allowing the actuator 102 to be suitably included in optical apparatuses, such as the high-speed driven mirror apparatus 100.

The fixed member 10 or 20 is provided with a first axis location sensor (omitted in the drawings), which detects the relative location of the driven member 30 along the Z-axis with respect to the fixed member 10 or 20. The actuator 102 includes the controller 50 including the first axis controlling portion, which controls, based on a signal from the first axis location sensor, magnetic force exertable by the first magnetic field generating portions 40. This structure makes it easy to magnetically levitate the driven member 30 with respect to the fixed members 10 and 20 and makes it easy to generate magnetic resonance between the magnetic members 32a1 to 32d1 (32a2 to 32d2) provided for the driven member 30 and the first magnetic field generating portions 40.

Moreover, in the present embodiment, the X-axis movable magnetic member 36a and the Y-axis movable magnetic member 36b are attached to the first surface 34a of the substrate 34. On the fixed member 10, which, with the predetermined space in between, opposes the magnetic members 36a and 36b, the magnetic field generating portions 60a and 60b, which can exert magnetic force on the magnetic members 36a and 36b, are disposed. This structure enables the magnetic field generating portion 60a or 60b to exert force on the movable magnetic member 36a or 36b so as to correct misalignment of the driven member 30 in a situation where, for example, gravity or the like may cause misalignment of the driven member 30 along the X-axis or the Y-axis with respect to the fixed member 10 or 20.

The fixed member 10 (or 20; the same applies hereafter) is provided with the location sensor 70, which detects the relative location of the driven member 30 along the X-axis or the Y-axis with respect to the fixed member 10. The actuator 102 includes the controller 50 including the X-axis controlling portion and the Y-axis controlling portion, which control, based on a detection signal from the location sensor 70, magnetic force exertable by the magnetic field generating portions 60a and 60b. This structure enables the location sensor 70 to detect misalignment of the driven member 30 and the controller 50 to control the magnetic field generating portions 60a and 60b so as to correct misalignment of the driven member 30 in a situation where, for example, gravity or the like may cause misalignment of the driven member 30 along the X-axis or the Y-axis with respect to the fixed member 10.

In the present embodiment, the X-axis controlling portion and the Y-axis controlling portion of the controller 50 collaborate (or double as each other). This enables control for preventing or reducing misalignment in the X-axis direction or the Y-axis direction and control for reducing a rotational movement of the driven member 30 with the Z-axis as a center. Note that, in the present embodiment, an X-axis sensor and a Y-axis sensor constitute the common sensor 70; however, the X-axis sensor and the Y-axis sensor may constitute different sensors. Also note that, while the controller 50 doubles as the X-axis controlling portion and the Y-axis controlling portion and, additionally, the Z-axis controlling portion in the present embodiment, they may constitute different controllers. However, they preferably collaborate with each other.

In the present embodiment, each of the magnetic members 32al to 32d1, 32a2 to 32d2, and 36a and 36b provided for the substrate 34 constitutes the magnet film composed of the multilayer film including the SmCo₅ film and the Sm₂Co₁₇ film and having a thickness of 300 μm or less. The magnet film with this structure has excellent magnetic properties and can be easily manufactured using, for example, the molten salt method. This structure also enables reduction in weight of the driven member 30.

In the present embodiment, each of the magnetic members 32al to 32d1, 32a2 to 32d2, and 36a and 36b provided for the substrate 34 has the multilayer structure including the Co layer, the Sm₂Co₁₇ film, and the SmCo₅ film in sequence. Although the mechanism is not clear, the interposition of the Sm₂Co₁₇ film in between enables the magnet to be anisotropic with the axis of easy magnetization, in a direction vertical to a surface of the Co layer, having a degree of orientation of 90% or more. The magnet film with this structure has excellent magnetic properties and can be easily manufactured using, for example, the molten salt method.

In the present embodiment, no interlayer is present between the Co layer and the Sm₂Co₁₇ film or between the Sm₂Co₁₇ film and the SmCo₅ film of the above multilayer structure. The magnet film with this structure has excellent magnetic properties and can be easily manufactured using, for example, the molten salt method.

The high-speed driven mirror apparatus 100 of the present embodiment can be used for, for example, LiDAR. LiDAR is an acronym of Light Detection And Ranging. It is a remote sensing method in which a target is irradiated with a light using a near-infrared light, a visible light, or ultraviolet radiation to capture its reflection light with a light sensor to measure ranges (a sensing method using a sensor from a remote location). LiDAR is also an acronym of Laser Imaging Detection And Ranging. Mostly, a target is irradiated with a pulsed near-infrared laser light to measure the time for the light to return after it reaches the target.

What is characteristic of LiDAR is that not only the distance to the target but also its location or shape can be accurately detected. LiDAR is expected to be applied to highly automated driving systems of vehicles or the like. Other than that, LiDAR is utilized for uses in which humans or things are detected with high accuracy, such as robotic vacuum cleaners and golf rangefinders in the civilian sector and automated guided vehicles (AGV) and service robots in the industrial machinery sector.

### Second Embodiment

As shown in FIG. 1B, a high-speed driven mirror apparatus 100A according to another embodiment of the present invention has structures similar to those of the mirror apparatus 100 of the first embodiment except for including an actuator 102A different from the actuator 102 shown in FIG. 1A as follows. The high-speed driven mirror apparatus 100A exhibits effects similar to those of the mirror apparatus 100.

In the present embodiment, similarly to the first embodiment, a substrate 34 as a driven member 30A is magnetically levitated with respect to fixed members 10 and 20, utilizing magnetic repulsion between a movable magnetic member 321 and fixed magnetic members 12a, 12b, 14a, and 14b and magnetic repulsion between a movable magnetic member 322 and fixed magnetic members 22a, 22b, 24a, and 24b. Additionally, in the present embodiment, the substrate 34 is coupled to the fixed member 10 or 20 using an elastic member 80.

The elastic member 80 is not limited. The elastic member is composed of, for example, a leaf spring or a coil spring and is configured to limit a movement of the driven member 30A along at least the X-axis and/or the Y-axis. Spring force of the elastic member 80 is exertable, for example, between the fixed member 10 or 20 and the driven member 30A so that the locations at which the movable magnetic members 321 and 322 and the fixed magnetic members 12a, 12b, 14a, 14b, 22a, 22b, 24a, and 24b oppose are maintained. Spring force of the elastic member 80 may also be exertable so that the location of the substrate 34 along the Z-axis is controlled between the fixed members 10 and 20.

The location at which the elastic member 80 is attached to the substrate 34 is not limited and may be anywhere between the fixed member 10 or 20 and the substrate 34. Examples of such locations include an outer circumferential location of the substrate 34 and a location on a first surface of the substrate 34 opposite its second surface 34b to which a mirror is attached.

In the present embodiment, in addition to being magnetically levitated with respect to the fixed members 10 and 20, the driven member 30A is coupled to the fixed member 10 or 20 using the elastic member. Thus, compared to a structure in which the weight of the driven member 30A is supported by only the elastic member, stress exertable on the elastic member is reduced to, in consequence, improve durability of the actuator. Mechanical resonance of the elastic member 80 may be used as well for the driven member to be driven at a high speed.

### Third Embodiment

As shown in FIG. 2B1 to 2B3, a high-speed driven mirror apparatus according to still another embodiment of the present invention has structures similar to those of the mirror apparatus 100 or 100A except for including an actuator 102B different from the actuator 102 shown in FIG. 1A or the actuator 102A shown in FIG. 1B as follows. The high-speed driven mirror apparatus according to the present embodiment exhibits effects similar to those of the mirror apparatus 100 or 100A.

The actuator 102B of the present embodiment includes at least one pair of first end-side magnetic members 32a1 and 32b1, which are provided near opposite ends of a driven member 30B along the X-axis, and a pair of second end-side magnetic members 32a2 and 32b2, which are located opposite the first end-side magnetic members 32a1 and 32b1 across a substrate 34 along the Z-axis.

Note that, in the present embodiment, unlike the first embodiment, third end-side magnetic members 32c1 and 32d1 are not included near opposite ends of the driven member 30B along the Y-axis. Also, unlike the first embodiment, fourth end-side magnetic members 32c2 and 32d2 are not included near opposite ends of the driven member 30B along the Y-axis.

Correspondingly, in the present embodiment, a fixed member 10 shown in FIG. 2B1 is not provided with fixed magnetic members 14a and 14b or corresponding magnetic generating portions 40 shown in FIG. 2A1; and a fixed member 20 shown in FIG. 2B3 is not provided with fixed magnetic members 24a and 24b shown in FIG. 2A3.

Consequently, in the present embodiment, the substrate 34 can be pivoted on a central axis parallel to the Y-axis. A second surface 34b of the driven member 30B can thus slope at a high speed, with the central axis parallel to the Y-axis as a pivot. Thus, reflection of a light that enters a mirror attached to the second surface 34b can have orientation of the light changed at a high speed. This enables a one-dimensional scanning movement of a light, allowing the actuator 102B to be suitably included in optical apparatuses, such as the high-speed driven mirror apparatus 100.

The present invention is not limited to the above embodiments and can be variously modified within the scope of the present invention.

The first magnetic field generating portions 40 are fixed, for example, at locations where magnetic force is appropriately exertable on at least either the first movable magnetic member 321 or the second movable magnetic member 322, to the fixed member 10 or 20. The first magnetic field generating portions 40 may, for example, be fixed to the second fixed member 20 and apply magnetic fields to the second movable magnetic member 322 attached to the second surface of the substrate 34 to minutely move the ends of the substrate 34 along the Z-axis. Alternatively, the first magnetic field generating portions 40 may be fixed to a fixed member other than the first fixed member 10 and the second fixed member 20 and may apply magnetic fields to, for example, the first movable magnetic member 321 and/or the second movable magnetic member 322 attached to the substrate 34 to minutely move the ends of the substrate 34 along the Z-axis.

In the above embodiments, the magnetic members 12a, 12b, 14a, 14b, 22a, 22b, 24a, and 24b attached to the fixed member 10 or 20 are composed of permanent magnets; however, they may be composed of electromagnets. In that situation, the magnetic field generating portions 40 may be integrally incorporated in the magnetic members 12a, 12b, 14a, 14b or 22a, 22b, 24a, 24b composed of the electromagnets.

Also, attaching an optical part (e.g., a lens, a prism, a beam splitter, a filter, a polarizer, an optical modulator, and a diffractive optical element) instead of the mirror to the substrates 34 of the driven members 30, 30A, and 30B enables the actuators according to the embodiments of the present invention to be included in high-speed driven optical apparatuses other than the high-speed driven mirror apparatuses. Moreover, attaching an electronic part other than the optical part or other part to the driven members enables the actuators according to the embodiments of the present invention to be used as other driving apparatuses. Other driving apparatuses include a solenoid, a cylinder, a pump, and VCM. Note that the driven members may have shapes other than the substrate shape.

### EXAMPLES

Hereinafter, the present invention is described based on a more detailed example. However, the present invention is not limited to this example.

In the present example, an actuator 102 of a high-speed driven mirror apparatus 100 shown in FIGS. 1A, 2A1 to 2A3, and 3 was modeled using CAD. The actuator 102 had external dimensions of 8 mm along the X-axis, 8 mm along the Y-axis, and 2 mm along the Z-axis. Magnetic members 32a1 to 32d2 as magnets had a width of 1 mm, a length of 4 mm, and a thickness of 0.2 mm. On the supposition that the material of the magnets was SmCo₅ (density: 8.4 g/cm³) and the material of a substrate was Co (density: 8.9 g/cm³), their masses were calculated for the model of the actuator 102. The magnets and the substrate weighed about 54 mg and about 60 mg, respectively. From this, it was assumed that the mass of a driven member 30 (including a mirror) was much smaller than 1 g. It was determined that, if levitation force exerted on the driven member 30 was larger than gravity exerted on the mass point of 1 g, the driven member 30 was able to maintain a levitated state.

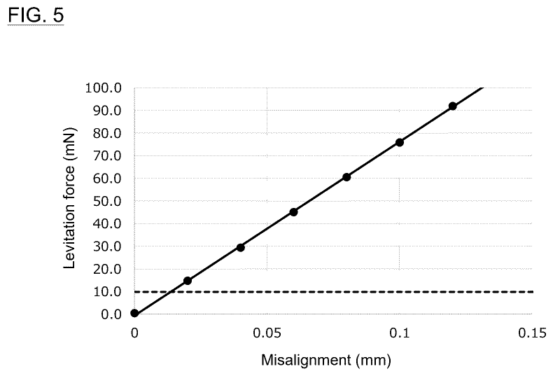

Changes in levitation force of the driven member 30 of the actuator 102 were found using a simulation (JMAG). The simulation provided the results shown in FIG. 5. The horizontal axis of FIG. 5 represents misalignment of the driven member 30 of the actuator 102 along the Z-axis in a gravitationally downward direction with respect to a midpoint in the Z-axis direction. The vertical axis of FIG. 5 represents the levitation force exerted on the driven member 30 in the Z-axis direction. Note that the midpoint of the driven member 30 in the Z-axis direction (point where the horizontal axis is 0 in FIG. 5) is based on the supposition that the driven member 30 shown in FIG. 1A is disposed at the midpoint between fixed magnetic members 12a (12b) and 22a (22b) along the Z-axis.

As shown in FIG. 5, it was found that, as the driven member 30 dropped by 0.02 mm from the midpoint in the Z-axis direction, repelling force against the fixed magnetic member 12a (12b ) increased to exert a levitation force of 15.8 mN on the driven member 30. The larger the drop amount, the more the levitation force. That is, it was confirmed that, because the levitation force exerted on the driven member 30 was larger than gravity at a drop amount of 0.02 mm or more, the driven member 30 was able to maintain a levitated state.

### REFERENCE NUMERALS

10 . . . first fixed member
12a, 12b, 14a, 14b . . . first fixed magnetic member
20 . . . second fixed member
21 . . . opening
22a, 22b, 24a, 24b . . . second fixed magnetic member
30, 30A, 30B . . . driven member
32a1, 32b1 . . . first end-side magnetic member
32a2, 32b2 . . . second end-side magnetic member
32c1, 32d1 . . . third end-side magnetic member
32c2, 32d2 . . . fourth end-side magnetic member
321 . . . first movable magnetic member
322 . . . second movable magnetic member
34 . . . substrate
34a . . . first surface
34b . . . second surface
35 . . . magnet film
35a . . . first film
35b . . . second film
36a . . . X-axis movable magnetic member
36b . . . Y-axis movable magnetic member
40 . . . first magnetic field generating portion
50 . . . controller
60a . . . second magnetic field generating portion
60b . . . third magnetic field generating portion
70 . . . sensor
80 . . . elastic member
100, 100A . . . high-speed driven mirror apparatus (high-speed driven optical apparatus)
102, 102A, 102B . . . actuator

1. An actuator comprising:
a fixed member; and
a driven member relatively movable with respect to the fixed member,
wherein
opposing magnetic members in pairs repelling each other using magnetic force to provide a predetermined space therebetween along a first axis are disposed on opposing surfaces in pairs of the driven member and the fixed member respectively; and
the fixed member is provided with a first magnetic field generating portion configured to exert magnetic force on at least one of the opposing magnetic members provided for the driven member to change a length of the predetermined space between the opposing magnetic members.

2. The actuator according to claim 1, wherein
the driven member comprises a first surface and a second surface opposite each other;
the at least one of the opposing magnetic members provided for the driven member comprises a first movable magnetic member on the first surface and a second movable magnetic member on the second surface;
at least another one of the opposing magnetic members provided for the fixed member comprises a first fixed magnetic member opposing the first movable magnetic member and a second fixed magnetic member opposing the second movable magnetic member; and
the first magnetic field generating portion is fixed, at a location where the magnetic force is appropriately exertable on at least either the first movable magnetic member or the second movable magnetic member, to the fixed member.

3. The actuator according to claim 2, wherein
the first movable magnetic member comprises at least one pair of first end-side magnetic members near opposite ends of the driven member along a second axis perpendicular to the first axis; and
the second movable magnetic member comprises a pair of second end-side magnetic members located opposite the at least one pair of first end-side magnetic members across the driven member along the first axis.

4. The actuator according to claim 1, wherein
the fixed member is provided with a first axis location sensor configured to detect a relative location of the driven member along the first axis with respect to the fixed member; and
the actuator further comprises a first axis controlling portion configured to control, based on a signal from the first axis location sensor, the magnetic force exertable by the first magnetic field generating portion.

5. The actuator according to claim 3, wherein
a second axis movable magnetic member configured to control a movement of the driven member along the second axis is attached between the at least one pair of first end-side magnetic members located on the first surface of the driven member; and
a second magnetic field generating portion is disposed on the fixed member opposing the second axis movable magnetic member with a predetermined space therebetween so that magnetic force is exertable by the second magnetic field generating portion on the second axis movable magnetic member.

6. The actuator according to claim 5, wherein
the fixed member is provided with a second axis location sensor configured to detect a relative location of the driven member along the second axis with respect to the fixed member; and
the actuator further comprises a second axis controlling portion configured to control, based on a detection signal from the second axis location sensor, the magnetic force exertable by the second magnetic field generating portion.

7. The actuator according to claim 3, wherein the second surface of the driven member has a mirror configured to reflect a light between the pair of second end-side magnetic members.

8. The actuator according to claim 3, wherein
the first movable magnetic member comprises at least one pair of third end-side magnetic members near opposite ends of the driven member along a third axis perpendicular to the first axis and the second axis; and
the second movable magnetic member comprises a pair of fourth end-side magnetic members located opposite the at least one pair of third end-side magnetic members across the driven member along the first axis.

9. The actuator according to claim 8, wherein
the fixed member is provided with a first axis location sensor configured to detect a relative location of the at least one pair of third end-side magnetic members along the first axis with respect to the fixed member; and
the actuator further comprises a first axis controlling portion configured to control, based on a signal from the first axis location sensor, the magnetic force exertable by the first magnetic field generating portion.

10. The actuator according to claim 8, wherein
a third axis movable magnetic member configured to control a movement of the driven member along the third axis is attached between the at least one pair of third end-side magnetic members located on the first surface of the driven member; and
a third magnetic field generating portion is disposed on the fixed member opposing the third axis movable magnetic member with a predetermined space therebetween so that magnetic force is exertable by the third magnetic field generating portion on the third axis movable magnetic member.

11. The actuator according to claim 10, wherein
the fixed member is provided with a third axis location sensor configured to detect a relative location of the driven member along the third axis with respect to the fixed member; and
the actuator further comprises a third axis controlling portion configured to control, based on a detection signal from the third axis location sensor, the magnetic force exertable by the third magnetic field generating portion.

12. The actuator according to claim 1, wherein the at least one of the opposing magnetic members provided for the driven member comprises a magnet film that is integrally provided on a surface of the driven member and has a thickness of 300 μm or less.

13. The actuator according to claim 12, wherein the magnet film comprises a multilayer film including a SmCo₅ film and a Sm₂Co₁₇ film.

14. The actuator according to claim 3, wherein the fixed member and the driven member are coupled using an elastic member configured to limit at least a movement of the driven member along the second axis.

15. A high-speed driven optical apparatus comprising the actuator according to claim 1.
